(19) United States
(12) Patent Application Publication
(10) Pub. No.: US 2007/0032965 A1
(43) Pub. Date: Feb. 8, 2007

(54) System and method for determining a paint formula with a portable device

(75) Inventors: Craig J. McClanahan, Bowling Green, OH (US); Paul W. Marshall, Grand Rapids, OH (US)

Correspondence Address: BASF CORPORATION, 1609 BIDDLE AVENUE, WYANDOTTE, MI, 48192, US

(73) Assignee: BASF Corporation, Southfield, MI (US)

(21) Appl. No.: 11/185,371

(22) Filed: Jul. 20, 2005

(51) Int. Cl. G01N 31/00; G06F 19/00

(52) U.S. Cl. 702/32

(57) ABSTRACT

A system and method determine a paint formula that matches the color of paint of a vehicle that is to be painted in a collision center. A plurality of paint formulas are stored in a database. A portable device, such as a PDA, is mobile relative to the vehicle and is in communication with the database via a wireless connection. Vehicle information is inputted into the portable device and sent to the database. The database determines the paint formula based on the vehicle information. The paint formula is communicated to the portable device. The portable device may display a color representation of the color of the paint formula which can be instantly compared to the existing color of the vehicle before mixing the paint or painting the vehicle.

### BACKGROUND OF THE INVENTION

1. Field of the Invention

The subject invention generally relates to a system and method for determining a paint formula that matches a color of paint of an object. Specifically, the subject invention relates to a system and method for determining a paint formula that matches the color of paint of a vehicle to be painted in a collision center.

2. Description of the Related Art

Portions of vehicles often need to be repainted, often as a result of a collision, paint scratch, etc. It is essential to match a color of the portion of the vehicle that is to be repainted to a color of a remainder of the vehicle. Various systems and methods are known in the art that assist in determining a paint formula for the portion of the vehicle that is to be repainted. Examples of such systems and methods are disclosed in U.S. Patent Application Publication Nos. 2003/0163262 to Corrigan et al. (the '262 publication) and 2004/0093112 to Marchand et al (the '112 publication).

The '262 publication discloses a network of remote terminals. Information about the vehicle that is to be repainted is entered into one of the remote terminals by a user. This information is then transmitted to a central computer. The central computer determines a paint formula that is the best match for the vehicle and forwards the paint formula to the remote terminal. The user can then prepare a quantity of paint based on the paint formula.

The '112 publication discloses a system and method for selecting colors when supplied with vehicle information. The system includes a computer having a display for displaying color reference chips after receiving the vehicle information. A color reference chip is selected and the system then provides a color formula based on a selected color reference chips.

Unfortunately, remote terminals, such as the terminals described in the '262 publication and the computer described in the '112 publication, are often desktop PCs stored in an office or bench of the collision center. As a result, the user wastes valuable time traveling between the vehicle and the remote terminal to gather and enter information about the vehicle and consulting with reference materials to verify the paint formula is the correct color. Also, those conventional remote terminals do not enable the user to compare a color side-by-side with the vehicle.

### SUMMARY OF THE INVENTION AND ADVANTAGES

The subject invention provides a method for determining a paint formula that matches a color of paint of an object, where a plurality of paint formulas are stored in a database. The method includes the step of inputting information associated with the object into a portable device. The portable device is mobile relative to the object. The method also includes the step of communicating the information between the portable device and the database. The method further includes the step of determining the paint formula from the plurality of paint formulas based on the information communicated between the portable device and the database.

The subject invention also provides a method for determining a paint formula that matches the color of paint of a vehicle to be repainted in a collision center. A plurality of paint formulas are stored in a database. The method includes the step of inputting vehicle information associated with the vehicle into a portable device that is mobile relative to the vehicle. The vehicle information is communicated between the portable device and the database. The method further includes the step of determining the paint formula from the plurality of paint formulas based on the vehicle information communicated between the portable device and the database.

The subject invention further provides a system for determining a paint formula that matches the color of paint of a vehicle. The system includes a database storing a plurality of paint formulas which correspond to vehicle information. A portable device is mobile relative to the vehicle and in communication with the database. The vehicle information that is inputted is received at the portable device and sent to the database. The portable device then receives the paint formula from the database. The portable device includes a display for displaying data related to the paint formula.

Since the portable device is mobile relative to the vehicle, critical time, productivity, and efficiency are gained in determining the paint formula for the vehicle or object.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1A is a schematic view of a preferred embodiment of a system according to the present invention illustrating a portable device in communication with a server computer storing a database via a local computer;

FIG. 1B is a schematic view of a first alternative embodiment of the system illustrating the portable device in communication with the server computer via a cellular telephone network;

FIG. 2 is a schematic view of the portable device in communication with other components of the system including a camera, a spectrophotometer, a barcode reader, and a dispensing apparatus; and

FIG. 3 is a block diagram of the steps of a method of the subject invention.

### DETAILED DESCRIPTION OF THE INVENTION

Referring to the Figures, wherein like numerals indicate corresponding parts throughout the several views, a system 10 and method 100 for determining a paint formula of an object are shown.

Preferably, the object is a vehicle 12 and the system 10 and method are utilized in a collision center in order to determine the paint formula necessary for painting a portion of the vehicle 12. The collision center may be an automotive repair facility, a bump shop, or a repair node at a vehicle manufacturing plant. For purposes of clarity only, the object will be referred to hereafter as the vehicle 12. However, this reference should not be read as limiting, as those skilled in the art realize that this invention may be practiced outside the confines of the collision center and with objects other than vehicles 12.

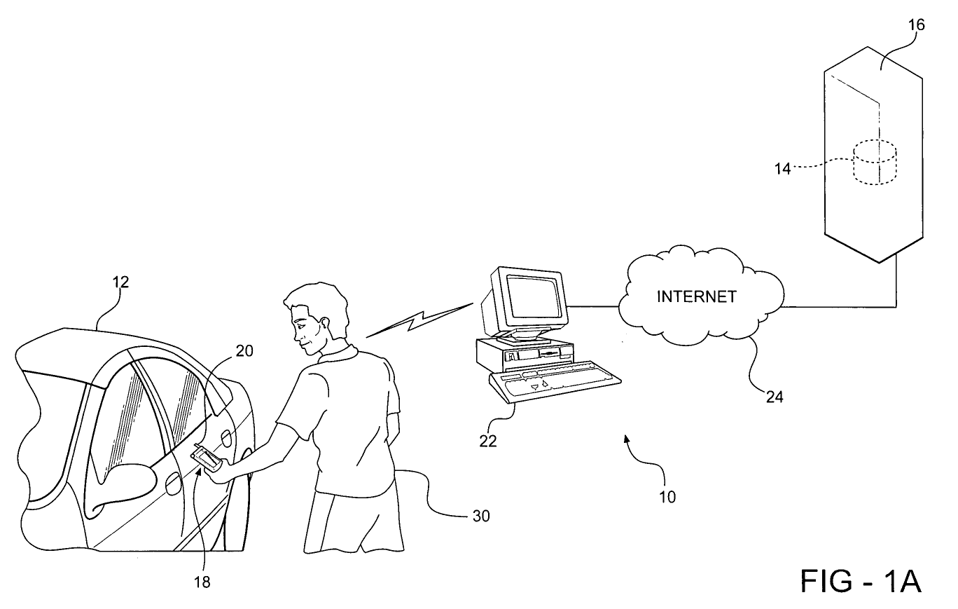

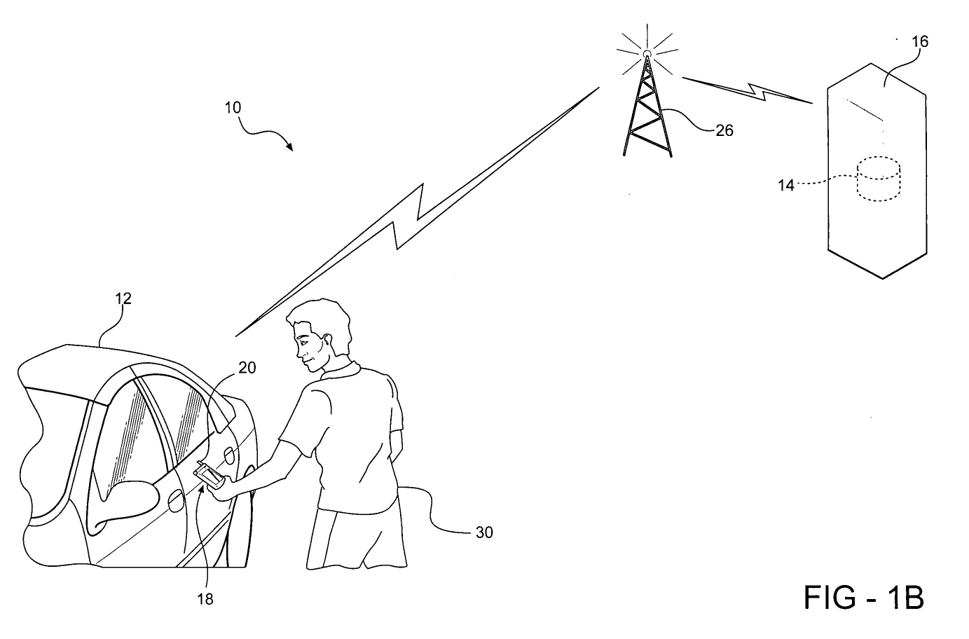

Referring to FIG. 1A, the system 10 includes a database 14. The database 14 is preferably a relational database 14 having a plurality of records which are related to one another. The various records of the database 14 may interact with one another; essentially sharing data between the various records. The database 14 includes a formula record storing a plurality of paint formulas. The paint formulas are “recipes” that specify a proportion of base and pigments needed to create a certain color of paint. The formula record may also include variations of each paint formula to match deviations that may have occurred in the original process of painting of the vehicle 12. Taken further, each variation may be assigned a “frequency score” which represents the how often the variation occurs in vehicle painting according to available statistics. The formula record may further contain one or more names of colors that correspond to each paint formula and its variations. For example, one paint formula and its variations may be assigned the name “green” for generic purposes and the name “Deep Forest Green” for manufacturer specific purposes.

The database 14 also includes a vehicle record. The vehicle record includes vehicle information associated with a plurality of vehicles 12 that have been manufactured by various automotive manufacturers. The vehicle information may include, but is not limited to, manufacturers of vehicles, brands/makes of vehicle, models of vehicles, model years of vehicles, production dates of vehicles, vehicle identification numbers (VINs), vehicle manufacturer paint codes, paint supplier paint codes, and the like. The vehicle information stored in the vehicle record corresponds to the paint formulas stored in the formula record such that an appropriate paint formula and variations of the paint formula can be retrieved given appropriate vehicle information. The vehicle record also preferably includes paint quantity information that provides a quantity of paint needed to paint particular portions of the vehicle 12 or the entire vehicle 12. The vehicle record further preferably includes positions on the vehicle (e.g., inside the drivers door, under the hood, etc.) where vehicle information, such as the VIN and paint codes may be located.

The database 14 may also include a collision center record for each collision center utilizing the system 10. Each collision center record includes information including, but not limited to, inventory data, customer data, and work order data. The inventory data may include the quantity of base and toner on hand at the collision center as well as a quantity of other fungible supplies. The customer data may include names, addresses, telephone numbers, insurance company, etc. for each customer service by the collision center. The work order data may include information on the vehicle 12 or vehicles 12 serviced or to be serviced at the collision center. This information may include the manufacturer of the vehicle 12, the brand/make of vehicle 12, the model of the vehicle 12, the model year of vehicle 12, the VIN, the vehicle manufacturer paint code, the paint supplier paint codes, the paint formula used to repaint the vehicle 12, and digital images (photographs) of the vehicle 12.

The database 14 may also include an estimating record. The estimating record provides cost estimates for repairs based on the damage to the vehicle 12. The estimating record is preferably provided by insurance companies to represent the amount of money covered for each repair. Furthermore, the database 14 may include a secondary color record. The secondary color record contains color combination information, such as a bumper color or a side mirror color that may be used in combination with a main body color.

In a preferred embodiment, the system 10 includes a server computer 16. The database 14 is stored within and is accessed by the server computer 16. The server computer 16 is preferably high-capacity, multi-user machine, capable of storing large volumes of information and handing multiple tasks for numerous clients.

The system 10 also includes a portable device 18 which is mobile relative to the vehicle 12. Preferably, the portable device 18 is a personal digital assistant (PDA) which can be held in a hand of a user 30 and is not fixed at a particular station. Suitable PDAs include, but are not limited to, those manufactured by palmOne, Inc., headquartered in Milpitas, Calif. or by Hewlett-Packard Company, headquartered in Palo Alto, Calif. Those skilled in the art realize that PDAs are often referred to as Pocket PCs, handheld computers, palmtop computers, etc. The portable device 18 may also be embodied as a cellular phone, a combination PDA/cellular phone, a laptop (or notebook) computer, a digital camera, or other portable electronic device as known to those skilled in the art.

The portable device 18 preferably includes a wireless transceiver 20. The wireless transceiver 20 allows communication, without a physical hard-wired connection, between the portable device 18 and other apparatus. The wireless transceiver 20 communicates using one or more wireless networking techniques, including, but not limited to, IEEE/ANSI 802.11 (WiFi) standards, Bluetooth® SIG specification, cellular telephony standards (TDMA, CDMA, GSM, etc.), and IrDA® standards

The portable device 18 is in communication with the database 14 for exchanging information between the portable device 18 and the database 14. In the preferred embodiment, where the database 14 is stored in the server computer 16, the portable device 18 is in communication with the server computer 16.

Also in the preferred embodiment, as shown in FIG. 1A, a local computer 22 is used as to facilitate the communication between the portable device 18 and the server computer 16. The portable device 18 communicates with the local computer 22 via the wireless transceiver 20 using one or more of the wireless networking techniques described above. The local computer 22 may communicate with the server computer 16 via a variety of techniques. Preferably, the local computer 22 and the server computer 16 communicate with each other via the Internet 24 using TCP/IP protocol. The connection between the local computer 22 and the Internet 24 may be via a dial-up connection over a POTS line, a T1 connection, an ISDN line, a digital subscriber line (DSL) connection, a wireless connection, or other suitable connection know to those skilled in the art.

Numerous alternative embodiments are possible to facilitate communication between the portable device 18 and the database 14. In a first alternative embodiment, as shown in FIG. 1B, the database 14 is stored in the server computer 16 and a cellular telephone network 26 is used to facilitate the communication between the portable device 18 and the server computer 16.

In a second alternative embodiment, a copy of the entire database 14 or portions of the database 14 are stored in the local computer 22. The local computer 22 effectively acts as a “mirror” to the database 14 in the server computer 16. The database 14 on the local computer 22 may be updated from the server computer 16 periodically (e.g., nightly) to ensure up-to-date information on the local computer 22. The local computer 22 communicates with the portable device 18 using wireless networking techniques as described above.

In a third alternative embodiment, a copy of the entire database 14 or portions of the database 14 are stored in the portable device 18 itself. The database 14 may be updated from the server computer 16 periodically. Those skilled in the art realize additional embodiments to facilitate communication between the portable device 18 and the database 14.

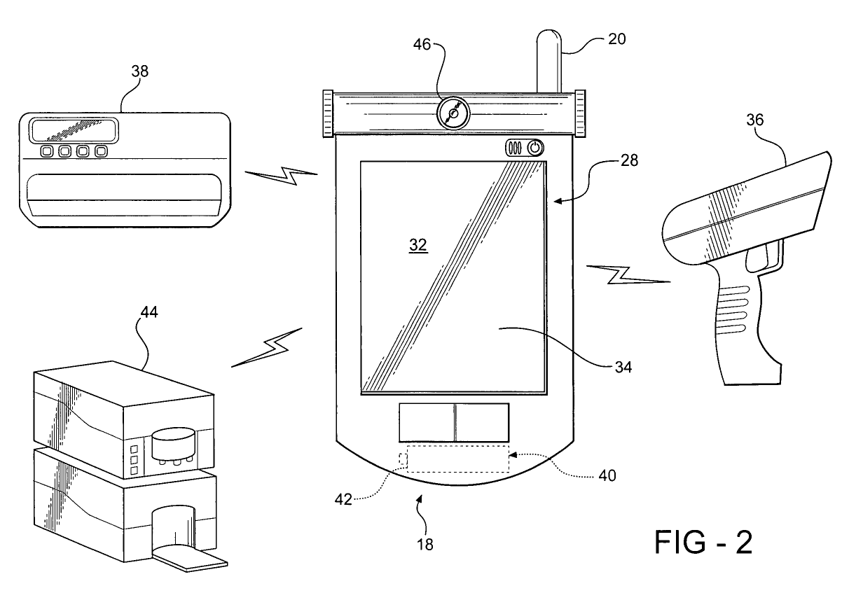

Referring now to FIG. 2, the portable device 18 includes a user interface 28 for receiving information from the user 30 and conveying information to the user 30. In the preferred embodiment of the PDA, the user interface 28 includes a display 32 for displaying information to the user 30 and a touchscreen 34 for receiving information from the user 30. The display 32 is preferably a color display 32 capable of displaying a plurality of colors. The touchscreen 34 preferably overlays the display 32, allowing the user 30 to input information and interact with information that is displayed. Alternative embodiments may include other instruments for receiving and conveying information to and from the user 30, including, but not limited to, a keyboard, a keypad, a speaker, a light, a light-emitting diode (LED), a microphone, a mouse, a trackball, and/or a handwriting recognition device, and the like.

The portable device 18 further includes a power source 40 for powering the portable device 18. The power source 40 is preferably a battery 42, either disposable or rechargeable. Alternatively, the power source 40 may be a solar cell (not shown). Furthermore, the solar cell may work in conjunction with the battery 42. By having its own power source 40, the portable device 18 is truly portable and not limited by a length of cord connecting it to a hard-wired wall outlet.

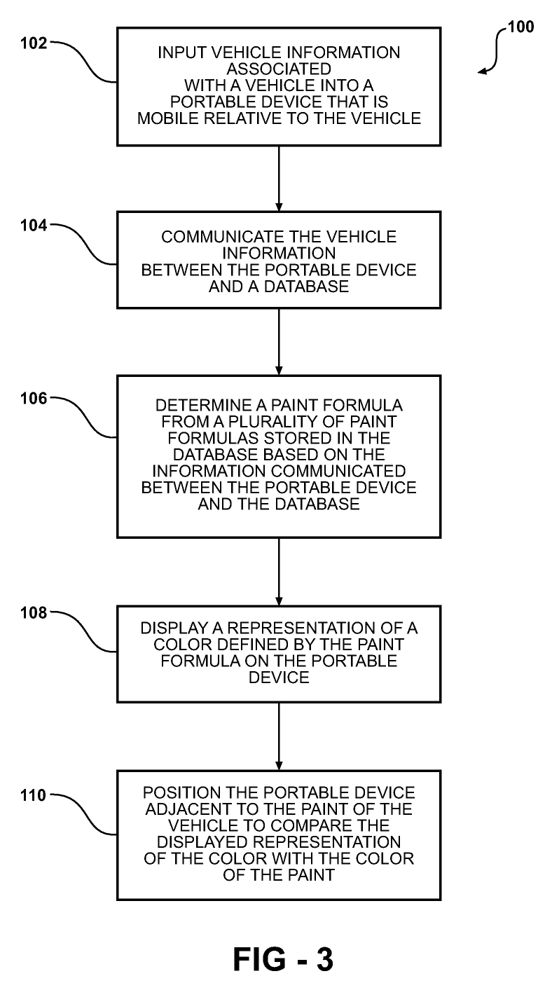

Referring now to FIG. 3, one method 100 of the subject invention includes the step 102 of inputting vehicle information that is associated with the vehicle 12 into the portable device 18. This vehicle information may be one of several forms as described in detail above and may be inputted as the user 30 is adjacent to the vehicle 12.

In a first case, the vehicle information may be the VIN of the vehicle 12. The VIN may be entered into the portable device 18 using the touchscreen 34. Referring again to FIG. 2, the system 10 may include a barcode reader 36, also commonly referred to as a barcode scanner, in communication with the portable device 18. The barcode reader 36 may be integrated with the portable device 18, an add-on attachment to the portable device 18, or a separate device that communicates with the portable device 18. The barcode reader 36 is used to scan a barcode that is affixed to the vehicle 12 and which encodes the VIN. Of course, the barcode reader 36 could be utilized to read barcodes that encode vehicle information other than the VIN.

In a second case, the vehicle information may be information entered via the touchscreen 34 using “drill-down” menus that prompt the user 30. For example, the user 30 may be asked to select the make/manufacturer/brand of the vehicle 12, then the model of the vehicle 12, model year of the vehicle 12, and the color of the vehicle 12.

In a third case, the system 10 may include a spectrophotometer 38 in communication with the portable device 18. The spectrophotometer 38 is used to measure the color of the paint of the vehicle 12. The spectrophotometer 38 generates the vehicle information based on its measurements. One suitable manufacturer of spectrophotometers 38 is X-Rite, Inc., headquartered in Grandville, Mich.

In a fourth case, the vehicle information may be the manufacturer paint code or the paint supplier paint code. Typically, these paint codes are located on a label found on the edge of the driver's door of the vehicle 12. These paint codes may also be encoded in a barcode and read by the barcode reader 36.

By utilizing the portable device 18 to enter the vehicle information, significant time savings will arise to the user 30, thus increasing the efficiency of the user 30 and the collision center. In contrast to the prior art, as described above, the user 30 need not write the information down and walk back to an office or bench to input the information into a PC. Furthermore, the portable device 18 can be utilized outside of the collision center, such as at a home or office of an owner of the vehicle 12, or wherever else the vehicle 12 may be located. Additionally, the portable device 18, in communication with the database 14, may provide data from the vehicle record to aid the user 30 in verifying vehicle information or finding the location of vehicle information on the vehicle 12. For example, the user 30 may enter the year, make, and model of the vehicle 12 into the portable device 18. In response, the portable device 18 communicates with the database and informs the user 30 of locations on the vehicle 12 where the VIN, paint codes, etc. may be found.

The method 100, as shown in FIG. 3, further includes the step 104 of communicating the vehicle information between the portable device 18 and the database 14. The vehicle information is received by the database 14 and the method 100 continues with the step 106 of determining at least one paint formula from the plurality of paint formulas based on the information communicated between the portable device 18 and the database 14.

The paint formula determined by the database 14 is then communicated from the database 14 to the portable device 18. Additionally, variations of each paint formula may also be sent to the portable device 18. The paint formula and variations are then displayed on the display 32. The user 30 can then consult reference material, such as color tool cards or color chips, which correspond to the paint formula and variations. By comparing the reference material to the paint of the vehicle 12, the user 30 can then select the paint formula or variation that most closely matches the paint of the vehicle 12. Other information, such as the frequency score of the paint formula and each variation, may also be displayed.

The color display 32 of the portable device 18 may also display 32 a representation of a color defined by the paint formula and/or the variations of the paint formula. This representation of the color defined by the paint formula can also include the impact of special effect pigments, such as aluminum and mica flakes, and their size, appearance, and concentration. The user 30 may position the portable device 18 adjacent to the paint of the vehicle 12 to compare the displayed representation of the color defined by the paint formula with the color of the paint of the vehicle 12. Several options are available to allow the user 30 to determine the best color match to the paint of the vehicle 12. In a first option, the color display 32 could cycle through representations of the paint formula and/or variations of the paint formula. The user 30 then selects the representation that best matches the paint of the vehicle 12. In a second option, a plurality of representations of the paint formula and/or the variations could be displayed on the display 32 simultaneously. The user 30 then selects the representation that best matches the paint of the vehicle 12.

For summary purposes, the method 100 may further include the step 108 of displaying a representation of a color defined by the paint formula on the mobile portable device and the step 110 of positioning the mobile portable device adjacent to the paint of the object to compare the displayed representation of the color with the color of the paint of the object.

A third option would display 32 the representation of paint formula or a variation. The user 30 may input paint formula adjustment information into the portable device 18. This paint formula adjustment information may be simple selectable commands such as “add a little green tint” or “subtract a lot of red tint”. The portable device 18, working in conjunction with the database 14, would then adjust the paint formula based on the paint formula adjustment information to generate an adjusted paint formula. The display 32 would then show a representation of the adjusted paint formula. The third option adjusting process described above could be repeated for numerous iterations in order to select the paint formula that most closely matches the color of the paint of the vehicle 12. Furthermore, the spectrophotometer 38 may be used in concert with the third option adjusting process to select a best possible variant of the paint formula and perform adjustments (i.e., tinting) to the paint formula based on sophisticated mathematical routines.

The system 10 may further include a dispensing apparatus 44. The dispensing apparatus 44 is in communication with the portable device 18 and therefore in communication with the database 14. The dispensing apparatus 44 regulates a quantity of base (e.g., resin) and toner in accordance with the selected paint formula and the quantity of paint that is needed. The quantity of base and toner required is provided by the formula record of the database 14. The portable device 18 sends the determined paint formula and quantity to the dispensing apparatus 44. The portable device 18 may also communicate the quantity of base and toner dispensed by the dispensing apparatus 44 back to the database 14. The inventory data of the collision center record is updated to reflect a consumption of the quantity of toner dispensed by the dispensing apparatus 44 in accordance with the determined paint formula.

The portable device 18 may also include a camera 46 in communication with the portable device 18. The camera 46 is utilized to capture an image or images (photographs) of the vehicle 12 or close-ups of the portions of the vehicle, such as the portions that need to be repaired. The images are then communicated to the collision center record of the database 14 for storage with the work order data. Before and after type images may be recorded to show quality of work and paint matching performance.

Obviously, many modifications and variations of the present invention are possible in light of the above teachings. The invention may be practiced otherwise than as specifically described within the scope of the appended claims.

1. A method for determining a paint formula that matches a color of paint of an object, where a plurality of paint formulas are stored in a database, said method comprising the steps of:
inputting information associated with the object into a portable device that is handheld and mobile relative to the object;
communicating the information between the portable device and the database;
determining the paint formula from the plurality of paint formulas based on the information communicated between the portable device and the database; and
displaying a representation of a color defined by the paint formula on the mobile portable device.

2. (canceled)

3. A method as set forth in claim 1 further comprising the step of positioning the mobile portable device adjacent to the paint of the object to compare the displayed representation of the color with the color of the paint of the object.

4. A method as set forth in claim 3 further comprising the step of inputting paint formula adjustment information into the mobile portable device.

5. A method as set forth in claim 4 further comprising the step of adjusting the paint formula based on the paint formula adjustment information.

6. A method as set forth in claim 1 further comprising the step of displaying the paint formula on the mobile portable device.

7. A method as set forth in claim 1 wherein said step of inputting information associated with the object into the mobile portable device is further defined as measuring the color of the paint.

8. A method as set forth in claim 1 further comprising the steps of establishing communication between the mobile portable device and a dispensing apparatus and regulating an amount of toner at the dispensing apparatus in accordance with the paint formula.

9. A method as set forth in claim 8 further comprising the step of updating inventory data based on the amount of toner dispensed by the dispensing apparatus in accordance with the determined paint formula to reflect a present inventory of toner.

10. A method for determining a paint formula that matches a color of paint of a vehicle to be painted in a collision center, where a plurality of paint formulas are stored in a database, said method comprising the steps of:
inputting vehicle information associated with the vehicle into a portable device that is handheld and mobile relative to the vehicle to be repainted in the collision center;
communicating the vehicle information between the portable device and the database;
determining the paint formula from the plurality of paint formulas based on the vehicle information communicated between the portable device and the database; and
displaying a representation of a color defined by the paint formula on the mobile portable device.

11. (canceled)

12. A method as set forth in claim 10 further comprising the step of positioning the mobile portable device adjacent to the paint of the vehicle to compare the displayed representation of the color with the color of the paint of the vehicle.

13. A method as set forth in claim 10 further comprising the step of displaying the paint formula on the mobile portable device.

14. A method as set forth in claim 13 further comprising the step of inputting paint formula adjustment information into the mobile portable device.

15. A method as set forth in claim 14 further comprising the step of adjusting the paint formula based on the paint formula adjustment information.

16. A method as set forth in claim 10 wherein said step of inputting vehicle information into the mobile portable device is further defined as measuring the color of the paint.

17. A method as set forth in claim 10 wherein said step of inputting vehicle information into the mobile portable device is further defined as inputting a vehicle identification number (VIN) into the mobile portable device.

18. A method as set forth in claim 17 wherein said step of inputting the VIN into the mobile portable device is further defined as scanning a barcode representing the VIN.

19. A method as set forth in claim 10 wherein said step of inputting vehicle information into the mobile portable device is further defined as inputting a paint code affixed to the vehicle.

20. A method as set forth in claim 10 further comprising the steps of establishing communication between the mobile portable device and a dispensing apparatus and regulating an amount of toner at the dispensing apparatus in accordance with the paint formula.

21. A method as set forth in claim 20 further comprising the step of updating inventory data based on the amount of toner dispensed by the dispensing apparatus in accordance with the determined paint formula to reflect a present inventory of toner.

22. A system for determining a paint formula that matches a color of paint of a vehicle, said system comprising:
a database storing a plurality of paint formulas corresponding to vehicle information;
a portable device that is mobile relative to the vehicle and in communication with said database for receiving the vehicle information that is inputted, sending the vehicle information to said database, and receiving the paint formula from the plurality of paint formulas from said database;
said portable device further including a color display for displaying a representation of the color defined by the paint formula; and
said portable device being handheld such that said color display may be positioned adjacent to the vehicle for comparing the representation of the color to the paint of the vehicle.

23. A system as set forth in claim 22 further comprising a server computer in communication with said mobile portable device and storing said database.

24. A system as set forth in claim 23 wherein said mobile portable device further includes a wireless transceiver for communicating with said server computer.

25. A system as set forth in claim 22 further comprising a spectrophotometer in communication with said mobile portable device for measuring the color of the paint.

26. A system as set forth in claim 25 wherein said spectrophotometer is integrated with said mobile portable device.

27. A system as set forth in claim 22 further comprising a barcode reader in communication with said mobile portable device for reading a barcode representing the vehicle information.

28. A system as set forth in claim 22 further comprising a camera in communication with said mobile portable device for capturing an image of the vehicle.

29. A system as set forth in claim 22 further comprising a dispensing apparatus in communication with said mobile portable device for receiving the paint formula and regulating an amount of toner in accordance with the paint formula.

30. (canceled)

31. A system as set forth in claim 22 wherein said mobile portable device further includes a power source for powering said mobile portable device.

32. A system as set forth in claim 30 wherein said power source comprises a battery.

33. A system as set forth in claim 22 further comprising a local computer in communication with said mobile portable device.

34. A system as set forth in claim 32 further comprising a server computer in communication with said local computer and storing said database.
